(19) United States
(12) Patent Application Publication
(10) Pub. No.: US 2019/0362242 A1
(43) Pub. Date: Nov. 28, 2019

(54) COMPUTING RESOURCE-EFFICIENT, MACHINE LEARNING-BASED TECHNIQUES FOR MEASURING AN EFFECT OF PARTICIPATION IN AN ACTIVITY

(71) Applicant: Microsoft Technology Licensing, LLC, Redmond, WA (US)

(72) Inventors: Jayadev Pillai, Bellevue, WA (US); Wenjie Hu, Bellevue, WA (US); Bo H. Moon, Bellevue, WA (US); Shan Yang, Bellevue, WA (US)

(21) Appl. No.: 15/989,772

(22) Filed: May 25, 2018

(51) Int. Cl. G06N 5/02; G06N 99/00; G06Q 30/02

(52) U.S. Cl. CPC G06N 5/02; G06Q 30/0255; G06N 99/005

(57) ABSTRACT

Embodiments are described herein for a compute resource-efficient technique for estimating a measurable effect attributable to participating in an activity. The foregoing is achieved by analyzing previously-collected features comprising different items of information associated with millions of users. The users comprise a first group that have participated in the activity and a second group that have not participated in the activity. Machine learning-based techniques are utilized to match users from each of the groups, with the goal being to match users having the same distribution of features. In particular, machine learning-based techniques are utilized to determine a propensity score for each user based on the features. Users from the first group are matched to users from the second group having a propensity score falling within a particular range. The measurable effect is determined based on an analysis of an average participation level of users matched in each range.

### BACKGROUND

Big data analytics is an approach to manage large amounts of data. As used herein, the term “big data” is used to describe large volumes (e.g., petabytes or exabytes) of data, which is immensely cumbersome for analysis. In most case, the analysis involves massive parallel processing as done, for example, using a plurality of central processing units (CPUs) and general purpose graphics processing units (GPGPUs). Such processing units may be configured to perform observational or controlled randomized experiments in order to analyze the data. Not only do such techniques result in a large amount of computing resource consumption, such techniques can also lead to inaccurate results, for example, in cases where self-selection bias is introduced in such experiments.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein are directed to estimating a measurable effect attributable to participating in an activity. The foregoing may be achieved by analyzing previously-collected features comprising different items of information (e.g., behavioral information) associated with millions of users. The users comprise a first group of users that have participated in the activity and a second group of users that have not participated in the activity. Machine learning-based techniques are utilized to match users from each of the first and second groups, with the goal being to match users having the same distribution of features. In particular, machine learning-based techniques are utilized to determine a propensity score for each user based on the features, which is indicative of a likelihood that a particular user is to participate in the activity. Users from the first group are matched to users from the second group having a propensity score falling within a particular range. The propensity score determination is performed using a significantly-reduced set of features that are nearly as effective for propensity score determination as the full set of features are determined. The measurable effect may be determined based on an analysis of an average participation level of users matched in each range of the propensity score.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 depicts a block diagram of a system for estimating a measurable effect attributable to an activity in which a user participates in accordance with example embodiment.

FIG. 2 depicts a block diagram of an effect determiner in accordance with an example embodiment.

FIG. 3 depicts a flowchart of an example method for determining a measurable effect attributable to an activity in accordance with an example embodiment.

FIG. 4 depicts a flowchart of an example method for determining a reduced set of a plurality of features in accordance with an example embodiment.

FIG. 5 depicts a flowchart of an example method for determining whether matched users of a first group and users of a second group are balanced in accordance with an example embodiment.

FIG. 6 depicts a block diagram of a balance checker in accordance with an example embodiment.

FIG. 7 is a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. System and Method for Estimating a Measurable Effect Attributable to Participating in an Activity

Embodiments described herein are directed to estimating a measurable effect attributable to participating in an activity. The foregoing may be achieved by analyzing previously-collected features comprising different items of information (e.g., behavioral information) associated with millions of users. The users comprise a first group of users that have participated in the activity and a second group of users that have not participated in the activity. Machine learning-based techniques are utilized to match users from each of first and second groups, with the goal being to match users having the same distribution of features. In particular, machine learning-based techniques are utilized to determine a propensity score for each user based on the features, which is indicative of a likelihood that a particular user is to participate in the activity. Users from the first group are matched to users from the second group having a propensity score falling within a particular range. The propensity score determination is performed using a significantly-reduced set of features that are nearly as effective for propensity score determination as the full set of features are determined. The measurable effect may be determined based on an analysis of an average participation level of users matched in each range of the propensity score.

By using the reduced set of features (as opposed to the full set), the amount of computing resources (e.g., processing, memory, etc.) required to determine the propensity scores and match users based thereon is significantly reduced. In particular, the techniques described herein can reduce the features by 90-95%. Given that the number of users can be anywhere from the millions or even billions, generating a propensity score and matching users using this limited set of features significantly utilizes a lesser amount of computing resources than compared to using the full set of features. Moreover, the foregoing techniques are applied on already-collected data (i.e., the features), which may have been collected over a course of weeks, months, or even years. Accordingly, a subsequent data collection step is not required, thereby conserving further computing resources. For example, additional memory does not need to be allocated because the data has already been collected. Furthermore, network bandwidth, which may be utilized to collect the data from different users, is also be conserved.

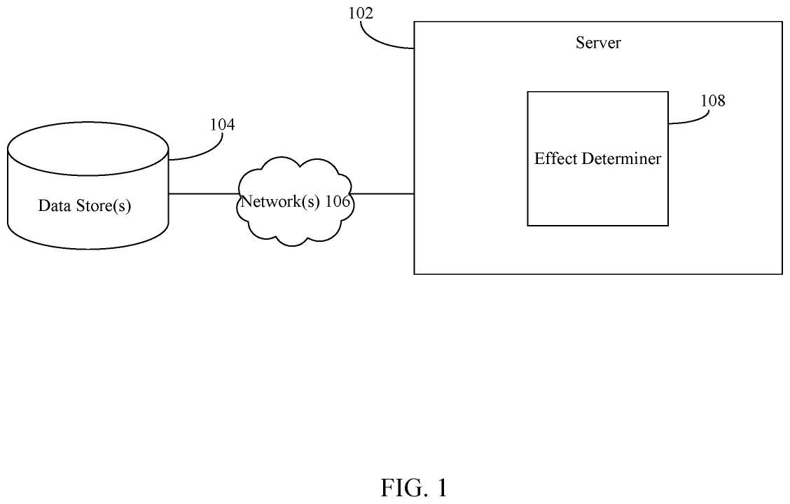

FIG. 1 is a block diagram of a system 100 for estimating a measurable effect attributable to an activity in which a user participates in accordance with an embodiment. As shown in FIG. 1, system 100 includes a server 102 and one or more data stores 104 communicatively coupled via one or more networks 106. Data store(s) 104 may comprise one or more physical memory and/or storage device(s). Data store(s) 104 may be any type of physical memory and/or storage device that is described herein, and/or as would be understood by a person of skill in the relevant art(s) having the benefit of this disclosure. Network(s) 106 may comprise one or more networks such as local area networks (LANs), wide area networks (WANs), enterprise networks, the Internet, etc., and may include one or more of wired and/or wireless portions.

Data store(s) 104 are configured to store data associated with a plurality of users (also referred to as “big data”). The plurality of users may comprise a first group of users that have participated in an activity and a second group of users that have not participated in the activity. The data may comprise different items of information (referred herein as “features”), such as, but not limited to, demographic information (e.g., age, gender, location, etc.) associated with each of the users of the first and second groups, a usage history associated with one or more devices and/or software applications associated with each of users of the first and second groups, purchase activity associated with each of the users of the first and second groups (e.g., a listing of new device purchases, software application purchases, etc.), advertising campaigns associated with each of the users of the first and second groups (e.g., advertisements that have been targeted to each of the users of the first and second groups, advertisements that have been interacted with (e.g., viewed, clicked on, etc.) by each of the users of the first and second groups, etc.), etc. Data store(s) 104 may store multiple days', weeks', months', and/or years' worth of such data.

Server 102 may comprise one or more server computers, which may include one or more distributed or “cloud-based” servers. As shown in FIG. 1, server 102 comprises an effect determiner 108. Server 102 is configured to obtain the data stored by data store(s) 104 and provide the data to effect determiner 108. Effect determiner 108 is configured analyze the features included in the data and match users of the first group to users of the second group. For example, effect determiner 108 may determine a propensity score for each of the users in the first and second groups based on the features. The propensity score may be generated using machine learning-based techniques. The propensity score is indicative of a likelihood that the particular user is to participate in the activity. Users from the first group falling within a particular range of the propensity score are matched to the users from the second group falling within the same range. Effect determiner 108 may estimate the measurable effect attributable to the activity based on a difference between an average participation level of users in the first group and a participation level of the users in the second group in each range of the propensity score.

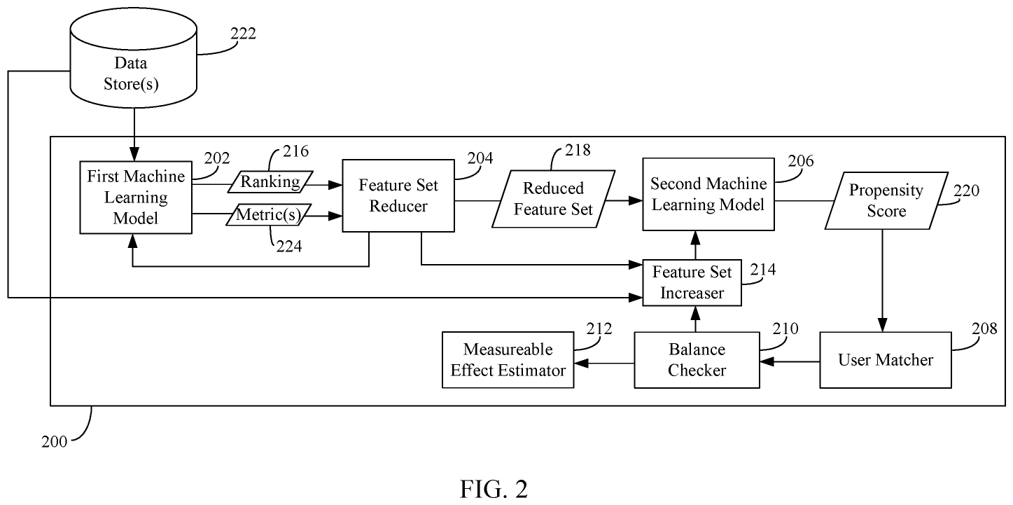

To conserve computing resources, effect determiner 108 reduces the number of features utilized when determining the propensity score. The reduced features may also be determined using machine learning-based techniques. Additional details regarding effect determiner 108 are described below in FIG. 2.

Effect determiner 108 may be configured to estimate a measurable effect for any kind of activity. One such activity is a joining a loyalty rewards program. In this example, the measurable effect may be a lift (e.g., revenue) attributed to a user joining such a program.

Loyalty rewards programs (e.g., Microsoft Rewards) are voluntary programs that offer incentives to users for purchasing products, filing out surveys, etc. Participating users earn points, which can be redeemed for apps, games, and other content. Because users are rewarded for each purchase, the intention of such programs is to motivate users to spend even more overall. The embodiments described herein may be utilized to estimate the lift in total revenue attributable to such programs.

One of the main issues in estimating a measurable effect attributable to an activity (e.g., lift for a loyalty rewards program, or for observational studies in general) is the inability to conduct a controlled randomized experiment. Users can be divided into two groups: a treated group, which contains the users who have participated in an activity (e.g., signing up for a loyalty rewards program), and a control group, which contains the users that have not participated in the activity (i.e., users that have not signed up for the loyalty rewards program). In an observational study, users may not be randomly assigned to either of these groups as in a controlled randomized test, so a measurable effect attributable to the activity (e.g., lift) cannot be directly computed as the difference of means between the treated and control groups.

To overcome this issue, the embodiments described herein utilize a technique referred to as propensity score matching to estimate a more reliable estimate for the effect attributable to an activity. In short, propensity score matching is performed by matching subgroups of the treated and control groups based on a metric called a propensity score, which indicates the likelihood that a user is to participate in a particular activity. In doing so, the matching emulates a controlled randomized experiment, so the difference of means can then be used to estimate the measurable effect attributable to the particular activity.

Subsection A, as described below, describes the theory behind propensity score matching and its justifications, and Subsection B, as further described below, describes techniques for propensity score matching and estimating a measurable effect based thereon.

A. Theory of Propensity Score Matching

1. Rubin's Causal Model

Rubin's causal model outlines the problem of measuring the effect on a response variable when a population unit is subject to a treatment. Let i be a unit from a population and Tᵢ∈{0,1} be a binary indicator variable denoting whether i received treatment. Furthermore, let Y₀ᵢ denote the response of unit i if they did not receive treatment, and Y₁ᵢ, be the response if they received treatment. For example, the units may be users, the treatment is the act of participating in an activity (e.g., signing up for a loyalty rewards program), and the response of interest (i.e., the measurable effect) is an average participation level depending on whether a user has participated in the activity (e.g., amount of revenue generated by a user depending on whether they joined the loyalty rewards program or not).

The average causal effect (ACE) is sometimes referred to as the average treatment effect on the treated (or ATT). This can be interpreted as the measured effect (e.g., lift), which is represented below in Equation 1:

ACE=E[Y₁ᵢ|T=1]−E[Y₀ᵢ|T=1] (Equation 1)

Equation 1 represents the average difference in responses for the treated group if they received treatment and if they did not received treatment. Note that in Equation 1 the term E[Y₁ᵢ|T=1] is merely the average treatment response, which can be found from an experiment or observational study. However, the other term E[Y₀ᵢ|T=1] represents the average response of treated users had they not been treated. Thus, for any given individual only one possible outcome could be measured. This is referred to as the fundamental problem of causal inference. Because unit i was either treated or not treated, only one of Y₁ᵢ, Y₀ᵢ can be measured. This makes Equation 1 impossible to evaluate unless the counterfactual can be found.

It is noted that the treatment effect cannot be approximated by a simple “difference of means” between the treated and untreated group, which is represented below in Equation 2:

Δμ=E[Y₁ᵢ|Tᵢ=1]−E[Y₀ᵢ|Tᵢ=0] (Equation 2)

where both terms are observed. Unfortunately, for observational studies, Δμ contains selection bias (SB), defined in accordance with Equation 3, which is shown below:

SB=E[Y₀ᵢ|Tᵢ=1]−E[Y₀ᵢ|Tᵢ=0] (Equation 3)

This can be seen by rewriting Δμ as shown below in Equation 4:

Δμ=ACE+SB (Equation 4)

Selection bias exists in observational studies because there are users who are naturally more inclined to voluntarily opt for treatment, which means their responses are influenced by factors beyond the treatment itself. Consequently, SB≠0, so Δμ≠ACE.

If selection bias is eliminated, then the difference of observed means is equal to the average causal effect. One way of achieving this is through controlled randomized experiments, where users are randomly assigned to be treated or not treated, thereby forcing SB=0. However, the treatment assignment mechanism cannot be randomized for observational studies, so this is not an option. To overcome this issue, embodiments described herein utilize propensity score matching to remove selection bias.

2. Propensity Scores

The Conditional Independence Assumption (CIA) states that the values of possible responses are conditionally independent of treatment when given the unit's feature vector Xᵢ:

Y₁ᵢ,Y₀ᵢ⊥Tᵢ|Xᵢ (Equation 5)

For this to be true, all possible factors that influence both response and treatment assignment must be accounted for in the observed features.

With this, one way to estimate the counterfactual Y₀ᵢ for a treated unit i is to use the measured response from an untreated unit j with very similar features. For example, if Euclidean distance is used as a similarity metric, then the following is true:

∥Xᵢ−Xⱼ∥₂≈0⇒Y₀ᵢ≈Y₀ⱼ (Equation 6)

However, as the number of features increases, the more unlikely it becomes to find exact or even approximate matches between the treated and untreated groups, so feature-matching in this manner is not optimal.

The Propensity Score Theorem says that when CIA holds, the following is true:

Y₁ᵢ,Y₀ᵢ⊥Tᵢ|PS(Xᵢ) (Equation 7)

where PS(Xᵢ) is the propensity score of a user i, defined in accordance with Equation 8, which is shown below:

PS(Xᵢ)=P(Tᵢ=1|Xᵢ) (Equation 8)

which can be estimated using a binary classifier. This means that treatment responses are independent of treatment assignment conditioned on the propensity score. It can be shown that conditioning on the propensity score removes the selection bias. In other words, if two groups of users have the same propensity score, then Δμ=ACE.

As described above, finding a treated user's counterfactual match becomes exceedingly difficult in high dimensions; however, the propensity score collapses the feature vector into a scalar, making it much more feasible to perform matching. It is worth noting that if two users have the same features, then they will have the same propensity score. On the other hand, if two users have the same propensity score, they may not have the same features—rather, two groups of users (of statistically significant sizes) with the same propensity score will have their features identically distributed.

Therefore, matching based on propensity score does not pair users who have the same feature values, but rather it groups users together based on features with the same distributions.

3. Matching Methods

Once propensity scores are calculated for all users, the treated and control groups are matched. In accordance with embodiments described herein, a stratification matching process is utilized. However, it is noted that other matching techniques may be used, such as, but not limited to, nearest neighbor or kernel matching techniques.

In stratified matching, users are grouped together by “buckets” or equal-sized intervals or ranges of propensity scores. It is noted that this is not a one-to-one or a pairing match; rather, a stratified match is a match between a group of users whose propensity scores fall in a specific range. Because users within a bucket have similar propensity scores, they also have similarly distributed features. Furthermore, the difference of means between the treated and control subgroups is equal to the average causal effect within each bucket. As such, the ACE (or the measurable effect) can be calculated via a weighted average over difference of means per bucket, as shown below with reference to Equation 9:

$$ACE = Δμ = \frac{1}{N} {\sum }_{i} {n}_{i} {Δμ}_{i} \qquad ( Equation 9 )$$

where nᵢ is the number of treated users in bucket i and N=Σᵢnᵢ.

B. System for Propensity Score Matching and Estimating a Measurable Effect of Participating in an Activity Based Thereon

FIG. 2 is a block diagram of an effect determiner 200 in accordance with an embodiment. Effect determiner 200 is an example of effect determiner 108, as described above with reference to FIG. 1. As shown in FIG. 2, effect determiner 200 comprises a first machine learning model 202, a feature set reducer 204, a second machine learning model 206, a user matcher 208, a balance checker 210, a measurable effect estimator 212 and a feature set increaser 214. Effect determiner 208 may be configured to estimate a measurable effect for any kind of activity. As described above, one such activity is a joining a loyalty rewards program. In this example, the measurable effect may be a lift in revenue attributed to a user joining the loyalty rewards program. The treated group consists of users that signed up for the loyalty rewards program, and the control group contains users who were eligible for the loyalty rewards program, but have not yet signed up.

To train a propensity score model, the probability that a given user will sign up for the loyalty rewards program may be estimated. This may be performed by analyzing features associated with the user. The features may include demographic information, a usage history associated with one or more devices and/or software applications, purchase activity (e.g., new device purchase activity), advertising campaigns associated with the user, or any other items of information that are predictive of a user signing up with a loyalty rewards program. New device features, in particular, are distinguishing because many users tend to sign up for loyalty rewards programs at the same time they make an expensive purchase (e.g., a new computer) in order to benefit from this large, but one-time purchase. The features may be stored in data store(s) 222. Data store(s) 222 may maintain features for both users that have signed up for a loyalty rewards program and users that have not signed up for a loyalty rewards program. Data store(s) 222 is an example of data store(s) 104, as described above with reference to FIG. 1.

Any given user may have thousands, or even tens of thousands of features associated therewith. This large dimensionality is problematic for verifying feature distributions are balanced after matching. As described above, users within the same bucket should theoretically have the same distribution of features. This distribution may be checked to empirically assess the quality of the propensity score model. If all the features are used for matching, each feature in each bucket must have the same distribution between the treated and untreated users. Given the number of features for each of the users, and the fact that there can millions or even billions of users, such a process is very compute intensive. That is, the processing power and memory required to properly match millions and millions of users based on thousands of features is immense. Thus, reducing the number of features would consume fewer computing resources and would be more likely to achieve a better matching. However, this runs the risk of violating the CIA by omitting features that may in fact be highly influential to both the treatment assignment and response.

The following disclosure describes techniques that reduce the number of features and also prevents the violation of the CIA. For example, first machine learning model 202 may be trained using all the features in data store(s) 222. In accordance with an embodiment, first machine learning model 202 may be a regression-based machine learning algorithm (e.g., a FastTree regression model) that analyzes a first time period's worth of features (e.g., one year) and determine an effectiveness of each of the plurality of features at predicting the likelihood that a particular user is to participate in an activity (e.g., signing up for a loyalty rewards program. First machine learning model 202 may also predict certain behavior of the users (e.g., whether or not a particular user is to sign up for a loyalty rewards program and/or an amount that the user may spend in another time period (e.g., the following year) based on the analysis. The predictions are compared to the actual data stored in data store(s) 222 for the time period for which the predictions were made to determine the accuracy of the predictions. First machine learning model 202 may output one or more prediction error metrics 224 (e.g., L1 (least absolute deviations) and L2 (least square errors) loss functions) that indicate how close the predictions were to the actual data. First machine learning model 202 also output a ranking 216 (or weights) for each of the features, where higher the ranking, the more effective that feature is at predicting the likelihood that a particular user is to sign up for a loyalty rewards program.

Feature set reducer 204 may be configured to remove an N number of lowest ranking features from the initial set of features used to train first machine learning model 202, where N is a positive integer. Feature set reducer 204 provides the remaining features to first machine learning model 202. First machine learning model 202 outputs prediction error metric(s) 224 and a ranking 216 for the remaining features. Feature set reducer 204 determines whether performance error metric(s) 224 are within a predetermined threshold of a prediction error metric associated with the initial set of the plurality of features. If the performance error metric(s) 224 are within the predetermined threshold, it means that the reduced feature set is substantially as effective at predicting the likelihood that a particular user is to participate in the activity. In such a case, feature set reducer 204 removes another N number of lowest ranking features from the remaining features and provides the remaining features to first machine learning model 202 to determine whether the feature set can be further reduced. The process described above iteratively reduces the number of features (by keeping the highest ranked features during each iteration) until the performance error metrics are not within the predetermined threshold. When the performance error metrics are not within the predetermined threshold, feature set reducer 204 adds the features removed during the last iteration back to last set of features used to train first machine learning model 202. By using this technique, the initial set of features (which, as described above, may consist of thousands of features) may be reduced to tens of features (e.g., a reduction of 90-95%). This reduced feature set (shown as reduced feature set 218) is provided to second machine learning model 206.

Second machine learning model 206 may be trained using reduced feature set 218 to determine a propensity score for each user (both users in the treated and controlled groups). Second machine learning model 206 may learn the values of reduced feature set 218 that correlate to a user participating in an activity (e.g., signing up for a loyalty rewards program) and determine a propensity score 220 for each user accordingly (e.g., the likelihood that a user is to sign up for the loyalty rewards program). The propensity score may be a value between 0.0 to 1.0. In accordance with an embodiment, second machine learning model 206 may utilize a gradient-boosted decision tree-based machine learning algorithm that performs a binary classification, where users that have performed the activity (e.g., users that have joined the loyalty rewards program) are labeled as Tᵢ=1 and users that have not participated in the activity (e.g., users that have not joined the loyalty rewards program) are labeled as Tᵢ=0. In the event that the positive ratio is low (e.g., less than 10 percent), the training data is upsampled to an appropriate positive ratio (e.g., a 10% positive ratio), while preserving the true positive ratio in the test set.

User matcher 208 matches users labeled Tᵢ=1 to users labeled Tᵢ=0 based on the users' propensity score. In particular, user matching 208 utilizes stratification technique, where users are grouped together by equal-sized ranges of propensity scores. In accordance with an embodiment, each range equals 0.001, thereby providing 1000 different buckets (e.g., 0.001, 0.002, 0.003, etc.). Users from each of the control group and the treated group falling with a particular range are matched based on their propensity score.

A common support level of the propensity scores may be established, which is an appropriate range of values where matching is feasible. If the distributions are too thin in some regions, then there may be an insufficient number of users in that range to represent an adequately large sample. As such, ranges of the propensity score that include a number of users that are less than a predetermined threshold (e.g., 100) may be ignored. Ranges in which feature balancing is poor may also be omitted, as described below with reference to Subsections B.1, B.2 and B.3.

Furthermore, propensity scores that are too close to either 0 or 1 may also be omitted. This is because a user with a propensity score of 1 or very close to 1 will almost certainly sign up for the loyalty rewards program. Thus, reasoning about the counterfactual would be difficult, i.e., attempting to find users who have not yet signed up for the loyalty rewards program, but will almost certainly sign up. An analogous argument holds for very low propensity scores.

For these reasons, the common support level may be restricted to the range of 0.1 to 0.9. That is, the users having propensity scores not in that range are omitted. It is noted that the treated and control groups may have clearly different distributions. This shows that the two groups can indeed be distinguished by their features. It is further noted that treated users may have distributions that skew towards 1, whereas the control group skews towards 0. This is reasonable because it is expected that the treated group to have higher propensity scores than most of the untreated users.

Balance checker 210 may be configured to determine whether the matching performed by user matcher 208 is balanced. Although the CIA from Equation 5 implies the Propensity Score Theorem in Equation 7, the converse is not necessarily true. Consequently, some empirical checks should be performed to ascertain that the CIA holds, thereby verifying that within a predetermined range the control group represents an appropriate counterfactual approximation to the treated group. This may be done by testing for balance, which is when various features of the two groups are similar.

Balance checker 210 may be configured to determine whether the matching is balanced using several techniques. Three techniques are described below:

1. Bias Reduction

Balance checker 210 may be configured to determine whether the matching is balanced by measuring the standardized bias. Not to be confused with selection bias, the standardized bias between the treated and control distributions is defined in accordance with Equation 10, which is shown below:

$$BIAS = \frac{{μ}_{t} - {μ}_{c}}{\sqrt{\frac{{V}_{t} + {V}_{c}}{2}}} \qquad ( Equation 10 )$$

where μₜ and μ_{c} are the means of the treated and control groups, and Vₜ and V_{c} are the variances of the treated and control groups. If the bias reduction is below a predetermined threshold (e.g., 5%), then balance checker 210 may determine that the standardized bias is acceptable.

2. Pre-Treatment Participation Level Comparison

Balance checker 210 may also be configured to determine the matching is balanced by analyzing the participation level (e.g., an amount of spend of users of the treated group) in a predetermined time period before they participated in an activity (referred to as the pre-treatment participation level) and the participation level of users in the control group in the same predetermined time period. In an example in which the activity is joining a loyalty rewards program, the expectation is that the treated group has spent more during this time period because bigger spenders are disproportionately more likely participate in the loyalty rewards program. As described above, after the matching process is performed by user matcher 208, the treated subgroup within each predetermined range should be associated with a control subgroup that has similar behavior (e.g., consumer behavior). In loyalty rewards program example, a good matching may be characterized by close to 0 average difference in revenue in the pre-treatment time period. Note that this is similar to an AA test, as the observed responses between the treated and untreated groups should be indistinguishable in the time leading up to the treatment. Accordingly, if balance checker 210 determines that the average difference in participation level is within a predetermined threshold, balance checker 210 may determine that the balance of the matching is acceptable.

3. Feature Distributions

Balance checker 210 may also be configured to determine the matching is balanced by analyzing the distribution of features between matched users. Matched users should exhibit a similar distribution of features. To verify this, balance checker 210 may perform the following operations: for each predetermined range of the propensity score, a two-sample t-test on each feature is performed to test if the means of each feature's distributions are equal between both the treated and untreated users. For example, if the reduced feature set comprises 100 features, this means there are 100 total variables to test. Thus, a good match should show most of the points lying close to 100 as possible. Accordingly, if the two-sample t-test indicates that majority of the points are close to the number of features in the reduced feature set, balance checker 210 may determine that the balancing of the matching is acceptable.

4. Unacceptable Balancing

Balance checker 210 may be configured to determine that the matching performed by user matcher 208 is not balanced if any of the three techniques described above indicate that the matching is unacceptable. That is, balance checker 210 may determine that the matching is balanced if all three techniques determine that the matching is balanced. In the event that balance checker 210 determines that the matching is not balanced, balance checker 210 may cause additional features to be added to the reduced feature. For example, balance checker 210 may send an indicator to feature set increaser 214. Feature set increaser 214 may retrieve reduced feature set 218 from feature set reducer 204, retrieve features from data store(s) 222 not included in reduced feature set 218, and add these features to reduced feature set 218. This new feature set is then provided to second machine learning model 214, which generates new propensity scores for each user, and the matching process and balance checking, as described above, are re-run based on these new propensity scores. This process is repeated until balance checker 210 determines that the matching performed by user matcher 208 is balanced. In the event that no balanced matched is achieved, it means that the features maintained by data store(s) 222 are not acceptable for matching purposes and that other features must be utilized in order to obtain balanced matches.

5. Estimating the Measurable Effect

In the event that balance checker 210 determines that the matches are balanced, measurable effect estimator 212 may estimate a measurable effect attributable to the activity (e.g., joining a loyalty rewards program) based on a difference between an average participation level of users in the treated group (e.g., the average spend of users who have joined the loyalty rewards program) and an average participation level of users in the control group (e.g., the average spend of users who have not joined the loyalty rewards program) in each predetermined range of the propensity score. In particular, the measurable effect may be determined in accordance with Equation 9, as described above in Subsection. In accordance with Equation 9, for each predetermined range i, the difference between an average participation level of users of the treated group and an average participation level of users of the control group in the predetermined range is weighted based on a number of users in the treated group in the predetermined range. The measurable effect is estimated based on the weighted difference divided by the total number of treated users.

C. Example Methods for Propensity Score Matching and Estimating a Measurable Effect of Participating in an Activity Based Thereon

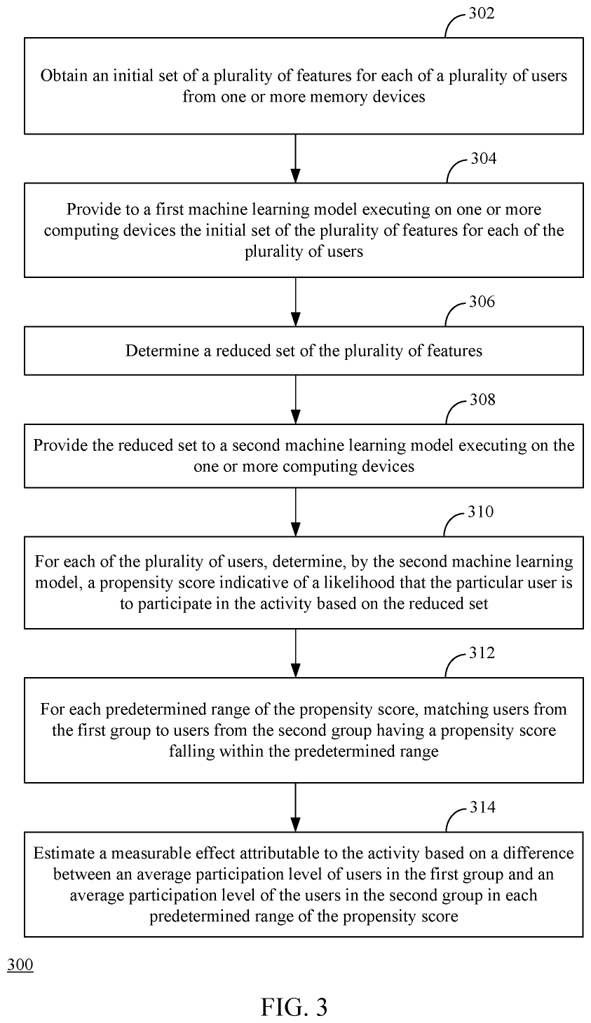

Accordingly, a measurable effect attributable to an activity may be determined in many ways. For example, FIG. 3 depicts a flowchart 300 of an example method for determining a measurable effect attributable to an activity in accordance with an example embodiment. The method of flowchart 300 will now be described with continued reference to effect determiner 200 of FIG. 2, although the method is not limited to that implementation. Other structural and operational embodiments will be apparent to persons skilled in the relevant art(s) based on the discussion regarding flowchart 300 and effect determiner 200 of FIG. 2.

As shown in FIG. 3, the method of flowchart 300 begins at step 302, in which an initial set of a plurality of features for each of a plurality of users is obtained from one or more memory devices. The plurality of users comprises a first group of users that have participated in an activity and a second group of users that have not participated in the activity. Each feature of the plurality of features comprise a different item of information for each of the plurality of users. For example, with reference to FIG. 2, an initial set of a plurality of features is obtained from data store(s) 222. The first group of users may be referred to as a treated group, and the second group of users may be referred to as a control group. In an example, the activity may be signing up for a loyalty rewards program. In accordance with this example, the first group may comprise users that have signed up for a loyalty rewards program, and the second group may comprise users that have not signed up for a loyalty rewards program.

In accordance with one or more embodiments, the plurality of features comprises at least one of a usage history associated with one or more devices associated with the plurality of users, demographic information associated with the plurality of users, purchase activity associated with the plurality of users, the purchase activity comprising information associated with new device purchases associated with the plurality of users, or advertising campaigns associated with the plurality of users.

At step 304, the initial set of the plurality of features for each of the plurality of users is provided to a first machine learning model executing on one or more computing devices. The plurality of features is utilized to train the first machine learning model to determine an effectiveness of each of the plurality of features at predicting the likelihood that a particular user is to participate in the activity. For example, with reference to FIG. 2, the initial set of the plurality of features are provided to first machine learning model 202.

In accordance with one or more embodiments, the first machine learning model is a regression-based algorithm.

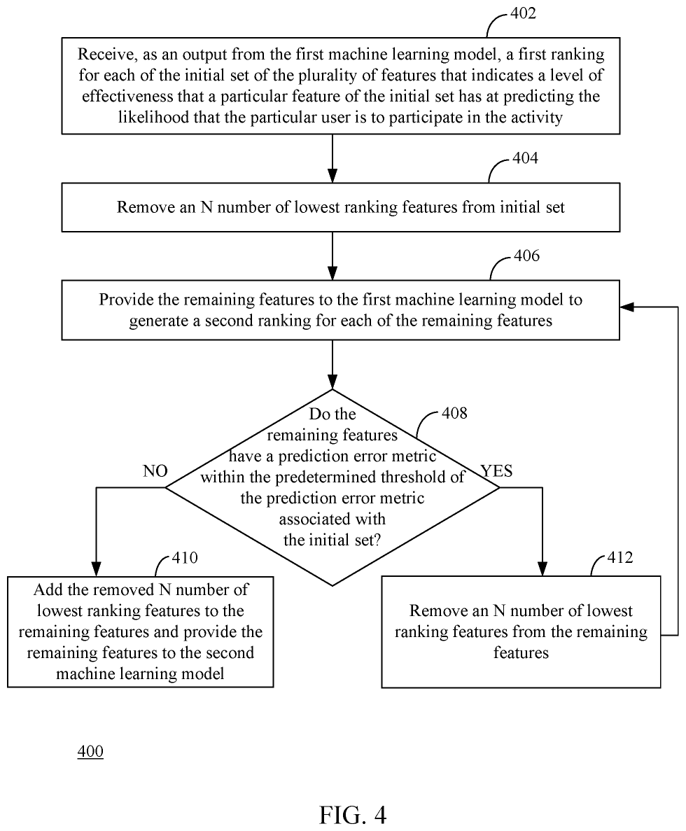

At step 306, a reduced set of the plurality of features are determined. The reduced set has a prediction error metric within a predetermined threshold of a prediction error metric associated with the initial set of the plurality of features. For example, with reference to FIG. 2, feature set reducer 204 determines a reduced set of the plurality of features (i.e., reduced feature set 218). Additional details regarding the operations performed by feature set reducer 204 are described below with reference to FIG. 4.

At step 308, the reduced set is provided to a second machine learning model executing on the one or more computing devices. For example, with reference to FIG. 2, reduced feature set 218 is provided to second machine learning model 206.

In accordance with one or more embodiments, the second machine learning model is a gradient-boosted decision tree-based algorithm.

At step 310, for each of the plurality of users, the second machine learning model determines a propensity score indicative of a likelihood that the particular user is to participate in the activity based on the reduced set, whereby the second machine learning model utilizes a lesser amount of computing resources with the reduced set than compared to using the initial set of the plurality of features for determining the propensity score. For example, with reference to FIG. 2, second machine learning model 206 determines, for each of the plurality of users, a propensity score 220 indicative of a likelihood that the particular user is to participate in the activity based on reduced feature set 218.

At step 312, for each predetermined range of the propensity score, users from the first group are matched to users from the second group having a propensity score falling within the predetermined range. For example, with reference to FIG. 2, for each predetermined range of the propensity score, user matcher 208 matches users from the first group to users from the second group having a propensity score 220 falling within the predetermined range.

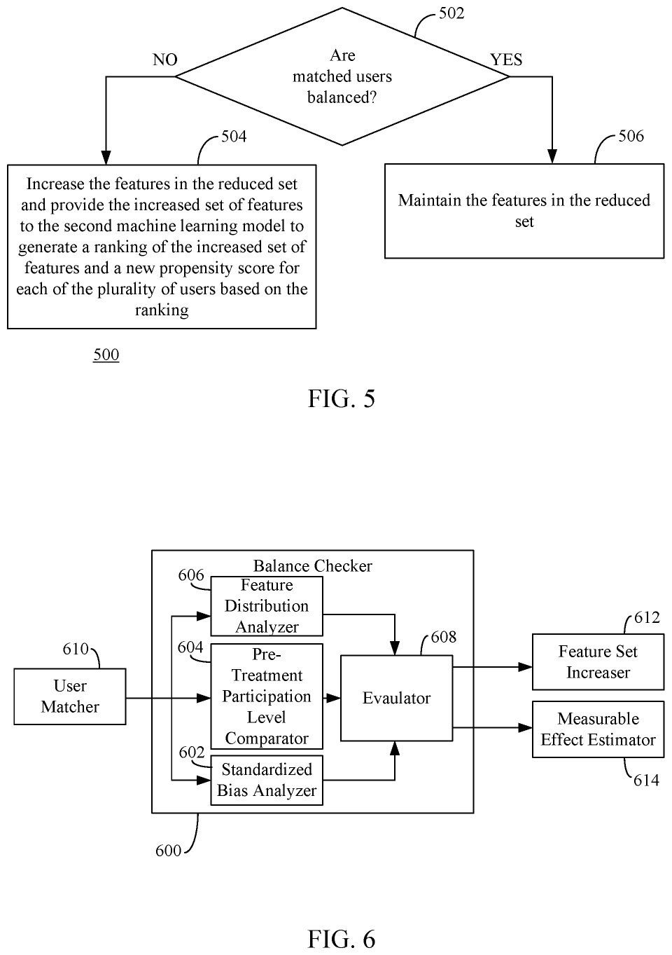

In accordance with one or more embodiments, the matching performed by user matcher 208 is analyzed by balance checker 210 to determine whether the matching is balanced. Additional details regarding determining whether the matching is balanced is described below with reference to FIGS. 5 and 6.

At step 314, a measurable effect attributable to the activity is estimated based on a difference between an average participation level of users in the first group and an average participation level of the users in the second group in each predetermined range of the propensity score. For example, with reference to FIG. 2, measurable effect estimator 212 estimates a measurable effect attributable to the activity based on a difference between an average participation level of users in the first group and an average participation level of the users in the second group in each predetermined range of propensity score 220. In an example in which the activity is joining a loyalty rewards program, the measurable effect may be the lift in revenue attributable to a user joining the loyalty rewards program, the average participation level of the users in the first group may be the average spend of users who have joined the loyalty rewards program, and the average participation level of users of the second group may be the average spend of users who have not joined the loyalty rewards program.

In accordance with one or more embodiments, estimating the measurable effect includes, for each predetermined range, weighting the difference between an average participation level of users of the first group and an average participation level of users of the second group in each predetermined range of the propensity score based on a number of users in the first group in the predetermined range, and estimating the measurable effect based on the weighted difference and a number of the plurality of users. In an example in which the activity is joining a loyalty rewards program, the average participation level of users in the first group is the average spend of the users that joined the loyalty rewards program, and the average participation level of users in the second group is the average spend of the users that that did not sign up for the loyalty rewards program.

FIG. 4 depicts a flowchart 400 of an example method for determining a reduced set of a plurality of features in accordance with an example embodiment. The method of flowchart 400 will now be described with continued reference to effect determiner 200 of FIG. 2, although the method is not limited to that implementation. Other structural and operational embodiments will be apparent to persons skilled in the relevant art(s) based on the discussion regarding flowchart 400 and effect determiner 200 of FIG. 2.

As shown in FIG. 4, the method of flowchart 400 begins at step 402, in which a first ranking for each of the initial set of the plurality of features is received as an output from the first machine learning model. The first ranking indicates a level of effectiveness that a particular feature of the initial set has at predicting the likelihood that the particular user is to participate in the activity. For example, with reference to FIG. 2, first machine learning model 202 outputs a ranking 216 for each of the initial set of the plurality of features.

At step 404, an N number of lowest ranking features from the initial set are removed, where N is a positive integer. For example, with reference to FIG. 2, feature set reducer 204 removes an N number of lowest ranking features from the initial set.

At step 406, the remaining features are provided to the first machine learning model to generate a second ranking for each of the remaining features. For example, with reference to FIG. 3, feature set reducer 204 provides the remaining features to first machine learning model 202 to generate a second ranking for each of the ranking features.

At step 408, a determination is made as to whether the remaining features have a prediction error metric within the predetermined threshold of the prediction error metric associated with the initial set. For example, with reference to FIG. 2, feature set reducer 204 determines whether the remaining features have a prediction error metric 224 within the predetermined threshold of the prediction error metric associated with the initial set. If a determination is made that the remaining features do not have a prediction error metric within the predetermined threshold of the prediction error metric associated with the initial set, flow continues to step 410. Otherwise, flow continues to step 412.

At step 410, the removed N number of lowest ranking features are added to the remaining features and the remaining features are provided to the second machine learning model, the remaining features being the reduced set. For example, with reference to FIG. 2, feature set reducer 204 adds the removed N number of lowest ranking features to the remaining features and provides the remaining features to second machine learning model 206.

At step 412, an N number of lowest ranking features are removed from the remaining features and steps 406, 408, and 412 are repeated until a determination is made that the prediction error metric of the remaining features is not within the predetermined threshold at step 408. As described above, upon such a determination, the removed N number of lowest ranking features are added to the remaining features, and the remaining features are provided to the second machine learning model, as described above with reference to step 410.

FIG. 5 depicts a flowchart 500 of an example method for determining whether matched users of a first group and users of a second group are balanced in accordance with an example embodiment. The method of flowchart 500 will now be described with reference to balance checker 600 of FIG. 6, although the method is not limited to that implementation. FIG. 6 is a block diagram of balance checker 600 in accordance with an embodiment. Balance checker 600 is an example of balance checker 210, as shown in FIG. 2. As shown in FIG. 6, balance checker 600 comprises a standardized bias analyzer 602, a pre-treatment participation level comparator 604, a feature distribution analyzer 606, and an evaluator 608. As further shown in FIG. 6, balance checker 600 is coupled to user matcher 610, feature set increaser 612 and measurable effect estimator 614. User matcher 610, feature set increaser 612 and measurable effect estimator 614 are examples of user matcher 208, feature set increaser 214 and measurable effect estimator 212, as described above with reference to FIG. 2. Other structural and operational embodiments will be apparent to persons skilled in the relevant art(s) based on the discussion regarding flowchart 500 and balance checker 600 of FIG. 6.

As shown in FIG. 5, the method of flowchart 500 begins at step 502, in which, for each predetermined range of the propensity score, a determination is made as to whether the matched users of the first group and users of the second group are balanced. For example, as shown in FIG. 6, balance checker 600 determines whether the matched users of the first group and users of the second group are balanced. If balance checker 502 determines that the match is not balanced, flow continues to step 504. Otherwise, flow continues to step 506.

In accordance with one or more embodiments, balance checker 600 may perform three techniques for determining whether the matching performed by user matcher 610 is balanced. For example, standardized bias analyzer 602 may perform an analysis of a standardized bias associated with the matched users of the first group and users of the second group as described above with reference to Subsection B.1. Pre-treatment participation level comparator 606 may perform an analysis between a participation level of the users in the first group in a time period before participating in the activity and a participation level of the users in the second group in the same time period as describe above with reference to Subsection B.2. Feature distribution analyzer 606 may be configured to perform an analysis of a distribution of features of the matched users of the first group and users of the second group to determine whether the matching is balanced in a similar manner as described above with reference to Subsection B.3. Each of standardized bias analyzer 602, pre-treatment participation level comparator 604 and feature distribution analyzer 606 may be configured to provide an indicator to evaluator 608 that indicates whether it has determined that the matching is balanced.

At step 504, the features in the reduced set are increased and provided to the second machine learning model to generate a ranking of the increased set of features and a new propensity score for each of the plurality of users based on the ranking. For example, with reference to FIG. 6, if one of the indicators provided by standardized bias analyzer 602, pre-treatment participation level comparator 604 or feature distribution analyzer 606 indicates that the matching is not balanced, evaluator 608 provides an indicator to feature set increaser 612, which causes feature set increaser 612 to increase the number of features and provides the increased set of features to second machine learning model (e.g., second machine learning model 206, as shown in FIG. 2) to generate a ranking of the increased set of features and a new propensity score for each of the plurality of users based on the ranking in a similar manner as described above with reference to FIG. 2.

At step 506, the features in the reduced set is maintained. For example, with reference to FIG. 6, if each of the indicators provided by standardized bias analyzer 602, pre-treatment participation level comparator 604 or feature distribution analyzer 606 indicates that the matching is balanced, no further changes are required to the reduced set and evaluator 608 provides an indicator to measurable effect estimator 614 that causes measurable effect estimator 614 to estimate the measurable effect as described above with reference to step 314 of FIG. 3.

### III. Example Computer System Implementation

The systems and methods described above in reference to FIGS. 1-6, may be implemented in hardware, or hardware combined with one or both of software and/or firmware. For example, effect determiner 108, effect determiner 200, first machine learning model 202, feature set reducer 204, second machine learning model 206, user matcher 208, balance checker 210, measurable effect estimator 212, feature set reducer 214, user matcher 610, balance checker 600, standardized bias analyzer 602, pre-treatment participation level comparator 604, feature distribution analyzer 606, evaluator 608, feature set increaser 612, and measurable effect estimator 614, and/or each of the components described therein, and flowchart 300, flowchart 400, and/or flowchart 500 may be each implemented as computer program code/instructions configured to be executed in one or more processors and stored in a computer readable storage medium. Alternatively, effect determiner 108, effect determiner 200, first machine learning model 202, feature set reducer 204, second machine learning model 206, user matcher 208, balance checker 210, measurable effect estimator 212, feature set reducer 214, user matcher 610, balance checker 600, standardized bias analyzer 602, pre-treatment participation level comparator 604, feature distribution analyzer 606, evaluator 608, feature set increaser 612, and measurable effect estimator 614, and/or each of the components described therein, and flowchart 300, flowchart 400, and/or flowchart 500 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

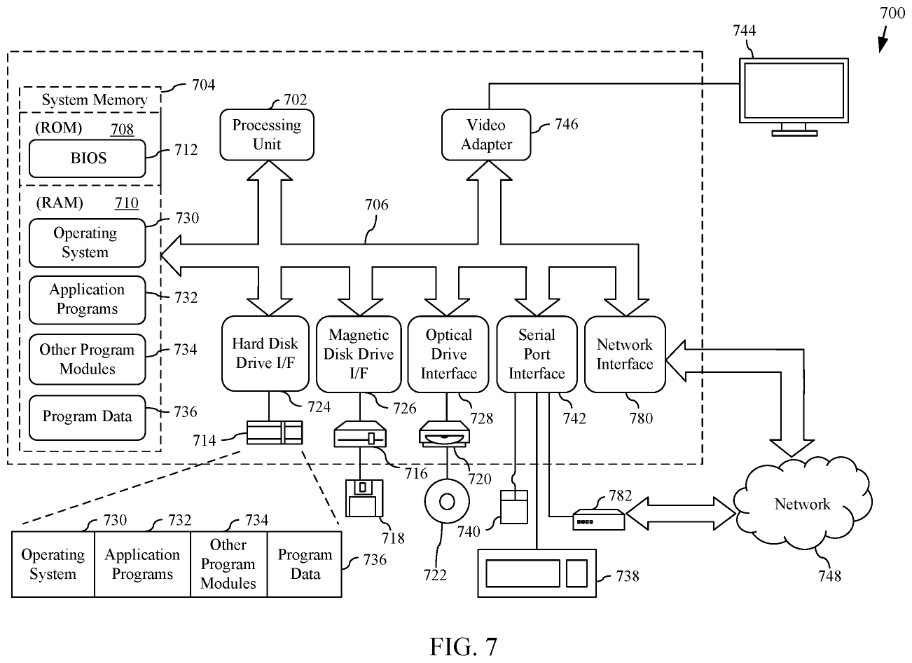

Furthermore, FIG. 7 depicts an exemplary implementation of a computing device 700 in which embodiments may be implemented, including server 102, data store(s) 104, data store(s) 222, effect determiner 108, effect determiner 200, first machine learning model 202, feature set reducer 204, second machine learning model 206, user matcher 208, balance checker 210, measurable effect estimator 212, feature set reducer 214, user matcher 610, balance checker 600, standardized bias analyzer 602, pre-treatment participation level comparator 604, feature distribution analyzer 606, evaluator 608, feature set increaser 612, and measurable effect estimator 614, and/or each of the components described therein, and flowchart 300, flowchart 400, and/or flowchart 500. The description of computing device 700 provided herein is provided for purposes of illustration, and is not intended to be limiting. Embodiments may be implemented in further types of computer systems, as would be known to persons skilled in the relevant art(s).

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 730, one or more application programs 732, other programs 734, and program data 736. Application programs 732 or other programs 734 may include, for example, computer program logic (e.g., computer program code or instructions) for implementing the systems described above, including the feature set reduction, propensity score determination, and measurable effect estimation techniques described in reference to FIGS. 1-6.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. Display screen 744 may display information, as well as being a user interface for receiving user commands and/or other information (e.g., by touch, finger gestures, virtual keyboard, etc.). In addition to display screen 744, computing device 700 may include other peripheral output devices (not shown) such as speakers and printers.

Computing device 700 is connected to a network 748 (e.g., the Internet) through an adaptor or network interface 780, a modem 782, or other means for establishing communications over the network. Modem 782, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to generally refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media (including system memory 704 of FIG. 7). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 732 and other programs 734) may be stored on the hard disk, magnetic disk, optical disk, ROM, RAM, or other hardware storage medium. Such computer programs may also be received via network interface 780, serial port interface 742, or any other interface type. Such computer programs, when executed or loaded by an application, enable computing device 700 to implement features of embodiments discussed herein. Accordingly, such computer programs represent controllers of the computing device 700.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

Embodiments described herein may also be implemented and/or executed via virtual or emulated hardware (e.g., virtual machines) and/or other environments, including, but not limited to, a cloud-computing based environment (e.g., Microsoft Azure by Microsoft Corporation ( ).

### IV. Additional Exemplary Embodiments

A method is described herein. The method includes, obtaining an initial set of a plurality of features for each of a plurality of users from one or more memory devices, the plurality of users comprising a first group of users that have participated in an activity and a second group of users that have not participated in the activity, each feature of the plurality of features comprising a different item of information for each of the plurality of users; providing to a first machine learning model executing on one or more computing devices the initial set of the plurality of features for each of the plurality of users, the plurality of features being utilized to train the first machine learning model to determine an effectiveness of each of the plurality of features at predicting the likelihood that a particular user is to participate in the activity; determining a reduced set of the plurality of features, the reduced set having a prediction error metric within a predetermined threshold of a prediction error metric associated with the initial set of the plurality of features; providing the reduced set to a second machine learning model executing on the one or more computing devices; for each of the plurality of users, determining, by the second machine learning model, a propensity score indicative of a likelihood that the particular user is to participate in the activity based on the reduced set, whereby the second machine learning model utilizes a lesser amount of computing resources with the reduced set than compared to using the initial set of the plurality of features for determining the propensity score; for each predetermined range of the propensity score, matching users from the first group to users from the second group having a propensity score falling within the predetermined range; and estimating a measurable effect attributable to the activity based on a difference between an average participation level of users in the first group and an average participation level of the users in the second group in each predetermined range of the propensity score.

In an embodiment of the method, determining the reduced set of the plurality of features comprises: (a) receiving, as an output from the first machine learning model, a first ranking for each of the initial set of the plurality of features that indicates a level of effectiveness that a particular feature of the initial set has at predicting the likelihood that the particular user is to participate in the activity; (b) removing an N number of lowest ranking features from the initial set, where N is a positive integer; (c) providing the remaining features to the first machine learning model to generate a second ranking for each of the remaining features; (d) determining whether the remaining features having a prediction error metric within the predetermined threshold of the prediction error metric associated with the initial set; (e) in response to determining that the prediction error metric of the remaining features is not within the predetermined threshold, adding the removed N number of lowest ranking features to the remaining features and providing the remaining features to the second machine learning model, the remaining features being the reduced set; (f) in response to determining that the prediction error metric of the remaining features is within the predetermined threshold: removing an N number of lowest ranking features from the remaining features; repeating steps (c)-(f) until a determination is made that the remaining features do not have a prediction error metric within the predetermined threshold of the prediction error metric associated with the initial set.

In an embodiment of the method, estimating the measurable effect comprises: for each predetermined range: weighting the difference between an average participation level of users of the first group and an average participation level of users of the second group in each predetermined range of the propensity score based on a number of users in the first group in the predetermined range; and estimating the measurable effect based on the weighted difference and a number of the plurality of users.

In an embodiment of the method, the plurality of features comprises at least one of: a usage history associated with one or more devices associated with the plurality of users; demographic information associated with the plurality of users; purchase activity associated with the plurality of users, the purchase activity comprising information associated with new device purchases associated with the plurality of users; or advertising campaigns associated with the plurality of users.

In an embodiment of the method, the first machine learning model is a regression-based algorithm.

In an embodiment of the method, the second machine learning model is a gradient-boosted decision tree-based algorithm.

In an embodiment of the method, for each predetermined range of the propensity score, matching users from the first group to users from the second group having a propensity score falling within the predetermined range comprises: for each predetermined range of the propensity score, determining whether the matched users of the first group and users of the second group are balanced; in response to determining that the matched users of the first group and users of the second group are not balanced, increasing the features in the reduced set and providing the increased set of features to the second machine learning model to generate a ranking of the increased set of features and a new propensity score for each of the plurality of users based on the ranking; and in response to determining that the matched users of the first group and users of the second group are balanced, maintaining the features in the reduced set.

In an embodiment of the method, for each predetermined range of the propensity score, determining whether the matched users of the first group and users of the second group are balanced is based on at least one of: an analysis of a standardized bias associated with the matched users of the first group and users of the second group; an analysis between a participation level of the users in the first group in a time period before participating in the activity and a participation level of the users in the second group in the same time period; or an analysis of a distribution of features of the matched users of the first group and users of the second group.

A computing device is also described herein. The computing device includes at least one processor circuit and at least one memory that stores program code configured to be executed by the at least one processor circuit. The program code includes: a first machine learning model configured to: receive an initial set of a plurality of features for each of a plurality of users from one or more memory devices, the plurality of users comprising a first group of users that have participated in an activity and a second group of users that have not participated in the activity, each feature of the plurality of features comprising a different item of information for each of the plurality of users, the plurality of features being utilized to train the first machine learning model to determine an effectiveness of each of the plurality of features at predicting the likelihood that a particular user is to participate in the activity; a second machine learning model configured to: receive a reduced set of the plurality of features, the reduced set having a prediction error metric within a predetermined threshold of a prediction error metric associated with the initial set of the plurality of features; and for each of the plurality of users, determine a propensity score indicative of a likelihood that the particular user is to participate in the activity based on the reduced set, whereby the second machine learning model utilizes a lesser amount of computing resources with the reduced set than compared to using the initial set of the plurality of features for determining the propensity score; a user matcher configured to, for each predetermined range of the propensity score, match users from the first group to users from the second group having a propensity score falling within the predetermined range; and a measurable effect estimator configured to estimate a measurable effect attributable to the activity based on a difference between an average participation level of users in the first group and an average participation level of the users in the second group in each predetermined range of the propensity score.

In an embodiment of the computing device, the reduced set of the plurality of features is determined by: (a) receiving, as an output from the first machine learning model, a first ranking for each of the initial set of the plurality of features that indicates a level of effectiveness that a particular feature of the initial set has at predicting the likelihood that the particular user is to participate in the activity; (b) removing an N number of lowest ranking features from the initial set, where N is a positive integer; (c) providing the remaining features to the first machine learning model to generate a second ranking for each of the remaining features; (d) determining whether the remaining features having a prediction error metric within the predetermined threshold of the prediction error metric associated with the initial set; (e) in response to determining that the prediction error metric of the remaining features is not within the predetermined threshold, adding the removed N number of lowest ranking features to the remaining features and providing the remaining features to the second machine learning model, the remaining features being the reduced set; (f) in response to determining that the prediction error metric of the remaining features is within the predetermined threshold: removing an N number of lowest ranking features from the remaining features; repeating steps (c)-(f) until a determination is made that the remaining features do not have a prediction error metric within the predetermined threshold of the prediction error metric associated with the initial set.

In an embodiment of the computing device, the measurable effect estimator is configured to estimate the measurable effect by: for each predetermined range: weighting the difference between an average participation level of users of the first group and an average participation level of users of the second group in each predetermined range of the propensity score based on a number of users in the first group in the predetermined range; and estimating the measurable effect based on the weighted difference and a number of the plurality of users.

In an embodiment of the computing device, the plurality of features comprises at least one of: a usage history associated with one or more devices associated with the plurality of users; demographic information associated with the plurality of users; purchase activity associated with the plurality of users, the purchase activity comprising information associated with new device purchases associated with the plurality of users; or advertising campaigns associated with the plurality of users.

In an embodiment of the computing device, the first machine learning model is a regression-based algorithm.

In an embodiment of the computing device, the second machine learning model is a gradient-boosted decision tree-based algorithm.

In an embodiment of the computing device, the computing device further comprises: a balance checker configured to: for each predetermined range of the propensity score, determine whether the matched users of the first group and users of the second group are balanced; in response to a determination that the matched users of the first group and users of the second group are not balanced, increase the features in the reduced set and provide the increased set of features to the second machine learning model to generate a ranking of the increased set of features and a new propensity score for each of the plurality of users based on the ranking; and in response to a determination that the matched users of the first group and users of the second group are balanced, maintain the features in the reduced set.

In an embodiment of the computing device, the balance checker comprises at least one of: a standardized bias analyzer configured to perform an analysis of a standardized bias associated with the matched users of the first group and users of the second group; a pre-treatment participation level comparator configured to perform an analysis between a participation level of the users in the first group in a time period before participating in the activity and a participation level of the users in the second group in the same time period; or a feature distribution analyzer configured to perform an analysis of a distribution of features of the matched users of the first group and users of the second group.

Another computing device is described herein. The computing device includes at least one processor circuit; and at least one memory that stores program code configured to be executed by the at least one processor circuit. The program code includes: a machine learning model configured to: for each of a plurality of users, determine a propensity score indicative of a likelihood that a particular user is to participate in an activity based on a plurality of features for each of the plurality of users, the plurality of users comprising a first group of users that have participated in an activity and a second group of users that have not participated in the activity, each feature of the plurality of features comprising a different item of information for each of the plurality of users; a user matcher configured to, for each predetermined range of the propensity score, match users from the first group to users from the second group having a propensity score falling within the predetermined range; and a measurable effect estimator configured to estimate a measurable effect attributable to the activity based on a difference between an average participation level of users in the first group and an average participation level of the users in the second group in each predetermined range of the propensity score.

In an embodiment of the computing device, the plurality of features comprises at least one of: a usage history associated with one or more devices associated with the plurality of users; demographic information associated with the plurality of users; purchase activity associated with the plurality of users, the purchase activity comprising information associated with new device purchases associated with the plurality of users; or advertising campaigns associated with the plurality of users.

In an embodiment of the computing device, the machine learning model is a gradient-boosted decision tree-based algorithm.

In an embodiment of the computing device, the measurable effect estimator is configured to estimate the measurable effect by: for each predetermined range: weighting the difference between an average participation level of users of the first group and an average participation level of users of the second group in each predetermined range of the propensity score based on a number of users in the first group in the predetermined range; and estimating the measurable effect based on the weighted difference and a number of the plurality of users.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method, comprising:
obtaining an initial set of a plurality of features for each of a plurality of users from one or more memory devices, the plurality of users comprising a first group of users that have participated in an activity and a second group of users that have not participated in the activity, each feature of the plurality of features comprising a different item of information for each of the plurality of users;
providing to a first machine learning model executing on one or more computing devices the initial set of the plurality of features for each of the plurality of users, the plurality of features being utilized to train the first machine learning model to determine an effectiveness of each of the plurality of features at predicting the likelihood that a particular user is to participate in the activity;
determining a reduced set of the plurality of features, the reduced set having a prediction error metric within a predetermined threshold of a prediction error metric associated with the initial set of the plurality of features;
providing the reduced set to a second machine learning model executing on the one or more computing devices;
for each of the plurality of users, determining, by the second machine learning model, a propensity score indicative of a likelihood that the particular user is to participate in the activity based on the reduced set, whereby the second machine learning model utilizes a lesser amount of computing resources with the reduced set than compared to using the initial set of the plurality of features for determining the propensity score;
for each predetermined range of the propensity score, matching users from the first group to users from the second group having a propensity score falling within the predetermined range; and
estimating a measurable effect attributable to the activity based on a difference between an average participation level of users in the first group and an average participation level of the users in the second group in each predetermined range of the propensity score.

2. The method of claim 1, wherein determining the reduced set of the plurality of features comprises:
(a) receiving, as an output from the first machine learning model, a first ranking for each of the initial set of the plurality of features that indicates a level of effectiveness that a particular feature of the initial set has at predicting the likelihood that the particular user is to participate in the activity;
(b) removing an N number of lowest ranking features from the initial set, where N is a positive integer;
(c) providing the remaining features to the first machine learning model to generate a second ranking for each of the remaining features;
(d) determining whether the remaining features having a prediction error metric within the predetermined threshold of the prediction error metric associated with the initial set;
(e) in response to determining that the prediction error metric of the remaining features is not within the predetermined threshold, adding the removed N number of lowest ranking features to the remaining features and providing the remaining features to the second machine learning model, the remaining features being the reduced set; and
(f) in response to determining that the prediction error metric of the remaining features is within the predetermined threshold:
removing an N number of lowest ranking features from the remaining features; and
repeating steps (c)-(f) until a determination is made that the remaining features do not have a prediction error metric within the predetermined threshold of the prediction error metric associated with the initial set.

3. The method of claim 1, wherein estimating the measurable effect comprises:
for each predetermined range:
weighting the difference between an average participation level of users of the first group and an average participation level of users of the second group in each predetermined range of the propensity score based on a number of users in the first group in the predetermined range; and
estimating the measurable effect based on the weighted difference and a number of the plurality of users.

4. The method of claim 1, wherein the plurality of features comprises at least one of:
a usage history associated with one or more devices associated with the plurality of users;
demographic information associated with the plurality of users;
purchase activity associated with the plurality of users, the purchase activity comprising information associated with new device purchases associated with the plurality of users; or
advertising campaigns associated with the plurality of users.

5. The method of claim 1, wherein the first machine learning model is a regression-based algorithm.

6. The method of claim 1, wherein the second machine learning model is a gradient-boosted decision tree-based algorithm.

7. The method of claim 1, wherein, for each predetermined range of the propensity score, matching users from the first group to users from the second group having a propensity score falling within the predetermined range comprises:
for each predetermined range of the propensity score, determining whether the matched users of the first group and users of the second group are balanced;
in response to determining that the matched users of the first group and users of the second group are not balanced, increasing the features in the reduced set and providing the increased set of features to the second machine learning model to generate a ranking of the increased set of features and a new propensity score for each of the plurality of users based on the ranking; and
in response to determining that the matched users of the first group and users of the second group are balanced, maintaining the features in the reduced set.

8. The method of claim 7, wherein, for each predetermined range of the propensity score, determining whether the matched users of the first group and users of the second group are balanced is based on at least one of:
an analysis of a standardized bias associated with the matched users of the first group and users of the second group;
an analysis between a participation level of the users in the first group in a time period before participating in the activity and a participation level of the users in the second group in the same time period; or
an analysis of a distribution of features of the matched users of the first group and users of the second group.

9. A computing device, comprising:
at least one processor circuit; and
at least one memory that stores program code configured to be executed by the at least one processor circuit, the program code comprising:
a first machine learning model configured to:
receive an initial set of a plurality of features for each of a plurality of users from one or more memory devices, the plurality of users comprising a first group of users that have participated in an activity and a second group of users that have not participated in the activity, each feature of the plurality of features comprising a different item of information for each of the plurality of users, the plurality of features being utilized to train the first machine learning model to determine an effectiveness of each of the plurality of features at predicting the likelihood that a particular user is to participate in the activity;
a second machine learning model configured to:
receive a reduced set of the plurality of features, the reduced set having a prediction error metric within a predetermined threshold of a prediction error metric associated with the initial set of the plurality of features; and
for each of the plurality of users, determine a propensity score indicative of a likelihood that the particular user is to participate in the activity based on the reduced set, whereby the second machine learning model utilizes a lesser amount of computing resources with the reduced set than compared to using the initial set of the plurality of features for determining the propensity score;
a user matcher configured to, for each predetermined range of the propensity score, match users from the first group to users from the second group having a propensity score falling within the predetermined range; and
a measurable effect estimator configured to estimate a measurable effect attributable to the activity based on a difference between an average participation level of users in the first group and an average participation level of the users in the second group in each predetermined range of the propensity score.

10. The computing device of claim 9, wherein the reduced set of the plurality of features is determined by:
(a) receiving, as an output from the first machine learning model, a first ranking for each of the initial set of the plurality of features that indicates a level of effectiveness that a particular feature of the initial set has at predicting the likelihood that the particular user is to participate in the activity;
(b) removing an N number of lowest ranking features from the initial set, where N is a positive integer;
(c) providing the remaining features to the first machine learning model to generate a second ranking for each of the remaining features;
(d) determining whether the remaining features having a prediction error metric within the predetermined threshold of the prediction error metric associated with the initial set;
(e) in response to determining that the prediction error metric of the remaining features is not within the predetermined threshold, adding the removed N number of lowest ranking features to the remaining features and providing the remaining features to the second machine learning model, the remaining features being the reduced set; and
(f) in response to determining that the prediction error metric of the remaining features is within the predetermined threshold:
removing an N number of lowest ranking features from the remaining features; and
repeating steps (c)-(f) until a determination is made that the remaining features do not have a prediction error metric within the predetermined threshold of the prediction error metric associated with the initial set.

11. The computing device of claim 9, wherein the measurable effect estimator is configured to estimate the measurable effect by:
for each predetermined range:
weighting the difference between an average participation level of users of the first group and an average participation level of users of the second group in each predetermined range of the propensity score based on a number of users in the first group in the predetermined range; and
estimating the measurable effect based on the weighted difference and a number of the plurality of users.

12. The computing device of claim 9, wherein the plurality of features comprises at least one of:
a usage history associated with one or more devices associated with the plurality of users;
demographic information associated with the plurality of users;
purchase activity associated with the plurality of users, the purchase activity comprising information associated with new device purchases associated with the plurality of users; or
advertising campaigns associated with the plurality of users.

13. The computing device of claim 9, wherein the first machine learning model is a regression-based algorithm.

14. The computing device of claim 9, wherein the second machine learning model is a gradient-boosted decision tree-based algorithm.

15. The computing device of claim 9, further comprising:
a balance checker configured to:
for each predetermined range of the propensity score, determine whether the matched users of the first group and users of the second group are balanced;
in response to a determination that the matched users of the first group and users of the second group are not balanced, increase the features in the reduced set and provide the increased set of features to the second machine learning model to generate a ranking of the increased set of features and a new propensity score for each of the plurality of users based on the ranking; and
in response to a determination that the matched users of the first group and users of the second group are balanced, maintain the features in the reduced set.

16. The computing device of claim 15, wherein the balance checker comprises at least one of:
a standardized bias analyzer configured to perform an analysis of a standardized bias associated with the matched users of the first group and users of the second group;
a pre-treatment participation level comparator configured to perform an analysis between a participation level of the users in the first group in a time period before participating in the activity and a participation level of the users in the second group in the same time period; or
a feature distribution analyzer configured to perform an analysis of a distribution of features of the matched users of the first group and users of the second group.

17. A computing device, comprising:
at least one processor circuit; and
at least one memory that stores program code configured to be executed by the at least one processor circuit, the program code comprising:
a machine learning model configured to:
for each of a plurality of users, determine a propensity score indicative of a likelihood that a particular user is to participate in an activity based on a plurality of features for each of the plurality of users, the plurality of users comprising a first group of users that have participated in an activity and a second group of users that have not participated in the activity, each feature of the plurality of features comprising a different item of information for each of the plurality of users;
a user matcher configured to, for each predetermined range of the propensity score, match users from the first group to users from the second group having a propensity score falling within the predetermined range; and
a measurable effect estimator configured to estimate a measurable effect attributable to the activity based on a difference between an average participation level of users in the first group and an average participation level of the users in the second group in each predetermined range of the propensity score.

18. The computing device of claim 17, wherein the plurality of features comprises at least one of:
a usage history associated with one or more devices associated with the plurality of users;
demographic information associated with the plurality of users;
purchase activity associated with the plurality of users, the purchase activity comprising information associated with new device purchases associated with the plurality of users; or
advertising campaigns associated with the plurality of users.

19. The computing device of claim 17, wherein the machine learning model is a gradient-boosted decision tree-based algorithm.

20. The computing device of claim 17, wherein the measurable effect estimator is configured to estimate the measurable effect by:
for each predetermined range:
weighting the difference between an average participation level of users of the first group and an average participation level of users of the second group in each predetermined range of the propensity score based on a number of users in the first group in the predetermined range; and
estimating the measurable effect based on the weighted difference and a number of the plurality of users.
